(19) United States
(12) Patent Application Publication
(10) Pub. No.: US 2009/0199412 A1
(43) Pub. Date: Aug. 13, 2009

(54) Manual Hair Trimmer

(75) Inventor: Rocky Cheng, Hong Kong (HK)

Correspondence Address: SCULLY SCOTT MURPHY & PRESSER, PC, 400 GARDEN CITY PLAZA, SUITE 300, GARDEN CITY, NY, 11530, US

(73) Assignee: PERFECT STEAM APPLIANCES LTD., Fo Tan, Shatin, N.T. (HK)

(21) Appl. No.: 12/301,712

(22) PCT Filed: May 15, 2007
(86) PCT No.: PCT/IB2007/001338

§ 371 Date: Nov. 20, 2008

(30) Foreign Application Priority Data
May 23, 2006 (IT) MI2006A001015

(51) Int. Cl. B26B 19/02

(52) U.S. Cl. 30/210

(57) ABSTRACT

A manual hair trimmer (1) comprising: a dome-shaped upper shell (2) and a substantially flat lower shell (3) coupled hermetically to the upper shell, a sealed chamber (4) being formed between the mutually coupled upper (2) and lower (3) shells; a motor drive (5) accommodated in the sealed chamber (4); a working head (6) provided with a set of hair cutting blades (7) and associated with the lower shell (3) on the opposite side with respect to the upper shell (2); and means (8) for transmitting motion from the motor drive (5) to the set of blades (7), which protrude from the lower shell (3), the dome being convex toward the outside so as to define a resting surface for a hand of a user.

### TECHNICAL FIELD

The present invention relates to a manual hair trimmer.

### BACKGROUND ART

Manual hair trimmers are known which comprise an elongated containment body, at one end of which two mutually superimposed blades are arranged: one is fixed and the other one can move with a reciprocating rectilinear motion along the first one.

The movable blade receives its motion from a motor accommodated within the containment body.

A grip handle is formed at the end of the containment body that lies opposite the two blades.

However, such known trimmers suffer drawbacks, including the fact that they cannot be used directly by the person whose hair is to be trimmed and require the intervention of an external operator, and therefore their use is limited only to hairdresser and barber salons and is infrequent at the personal and household level.

Another drawback of known trimmers consists in that their grip and handling are awkward and make it difficult to trim hair in the several regions of the head, since the operator must resort to flexing and twisting his hand in order to be able to orient the blades in the intended direction.

Another drawback of known trimmers consists in that, though meeting the necessary safety requirements, they cannot be used in particularly humid environments, such as for example under the shower.

### DISCLOSURE OF THE INVENTION

The aim of the present invention is to provide a manual hair trimmer that can be used directly and easily even by the person whose hair is to be trimmed without requiring the intervention of an external operator and therefore can also be used at the personal and household level.

Another object of the present invention is to provide a hair trimmer that can be gripped and handled easily by users, be they the persons whose hair is to be trimmed or external operators.

Another object of the present invention is to provide a hair trimmer that allows to trim simply and precisely the hair of any part of the head without having to assume awkward position with one's hands.

Still another object of the present invention is to provide a hair trimmer that can be used in full safety even in particularly humid environments.

Within this aim, an object of the present invention is to achieve said aim and objects with a structure which is simple, relatively easy to provide in practice, safe in use, effective in operation, and relatively low in cost.

This aim and these objects are all achieved by the present manual hair trimmer, characterized in that it comprises a dome-shaped upper shell and a substantially flat lower shell coupled hermetically to the upper shell, the dome being convex toward the outside so as to define a resting surface for the hand of a user.

In a preferred embodiment, a sealed chamber for accommodating a motor or drive unit is defined between the upper and lower shells, which are mutually coupled, and there are also a working head, which is provided with a set of hair trimming blades and is associated with the lower shell on the opposite side with respect to the upper shell, and means for transmitting motion from the drive unit to the set of blades, which protrude from the lower shell.

In another preferred embodiment, the working head is associated with the lower shell so that it can rotate about a rotation axis which is perpendicular to the plane formed by said lower shell, means for stopping the working head in preset angular positions being provided.

In a preferred embodiment, the trimmer comprises means for locking the hand of the user on the resting surface.

In another preferred embodiment, the dome of the upper shell is spherical, ovoid, oval or the like.

### BRIEF DESCRIPTION OF THE DRAWINGS

Further characteristics and advantages of the present invention will become better apparent from the detailed description of a preferred but not exclusive embodiment of a manual hair trimmer according to the invention, illustrated by way of non-limiting example in the accompanying drawings, wherein:

FIG. 1 is a perspective view of a hair trimmer according to the invention;

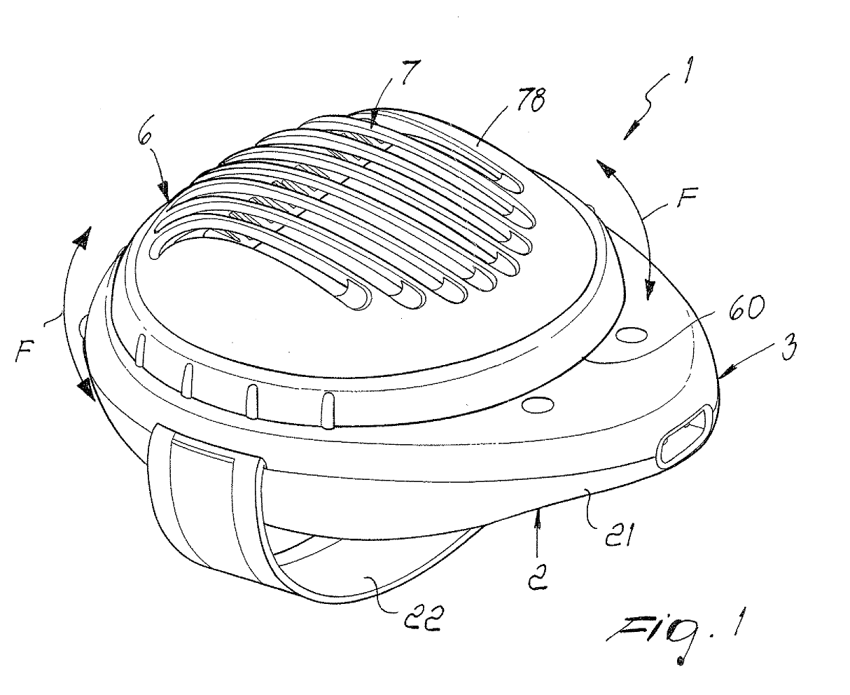

FIG. 2 is a partially exploded view of the hair trimmer according to the invention;

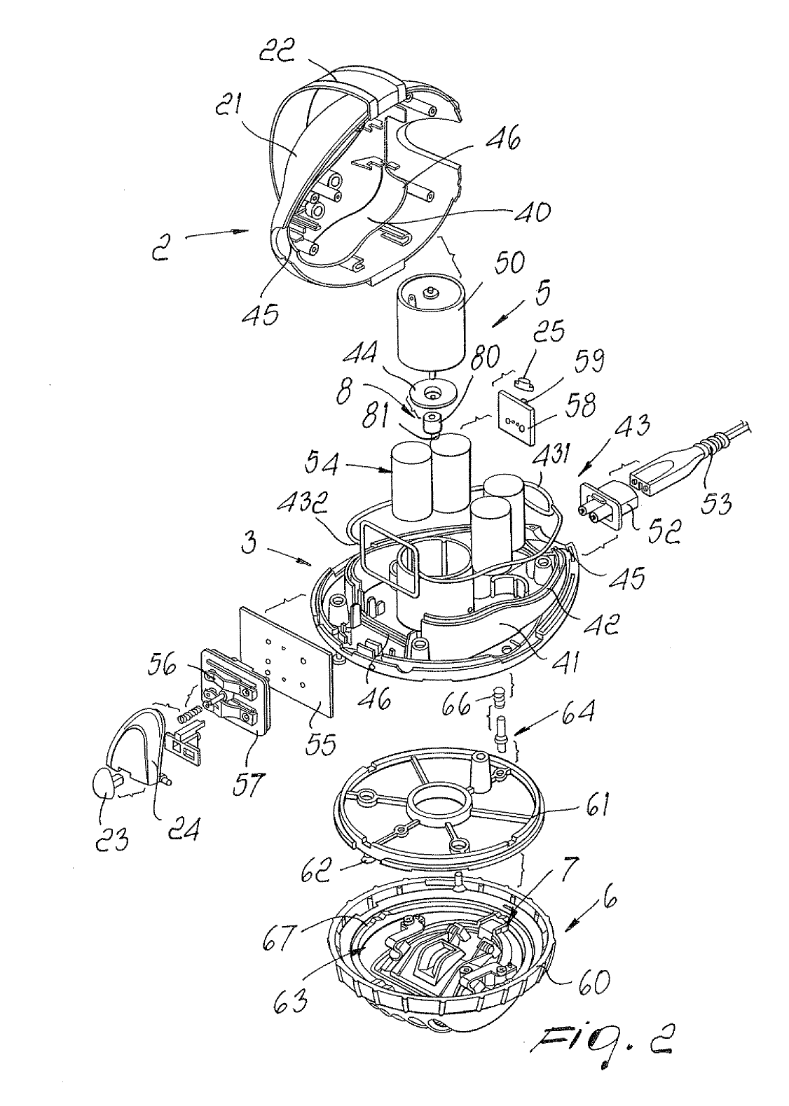

FIG. 3 is an exploded view of the working head of the hair trimmer according to the invention;

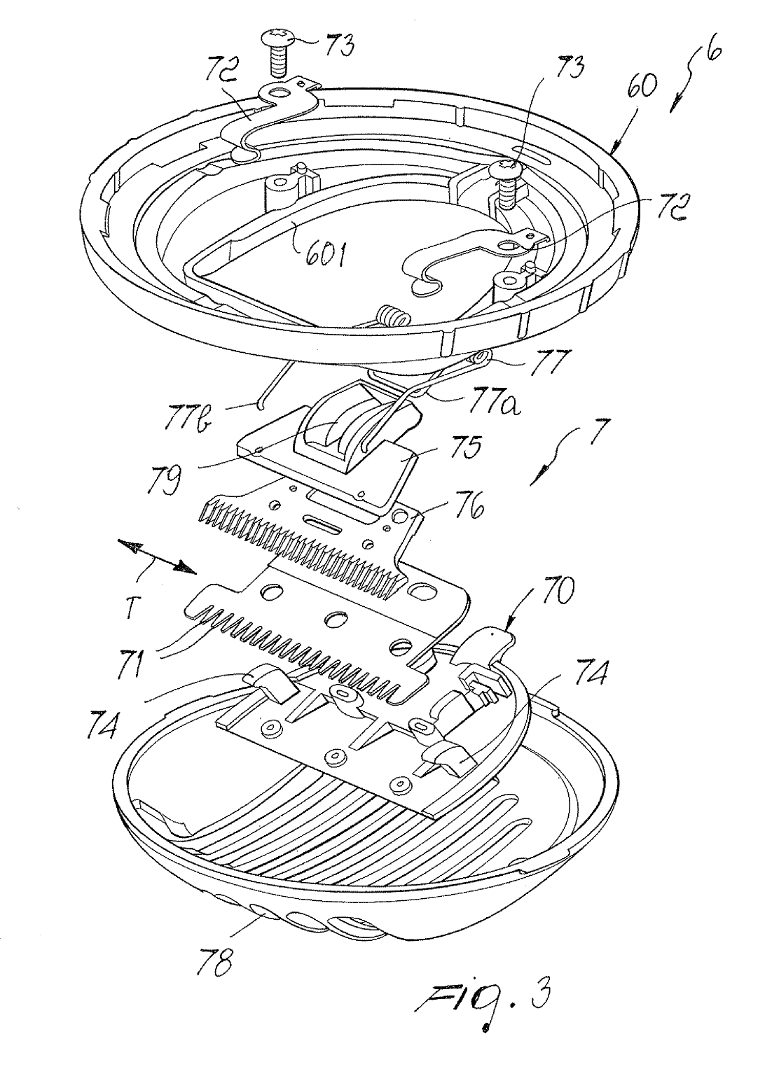

FIG. 4 is a schematic sectional view of the hair trimmer according to the invention;

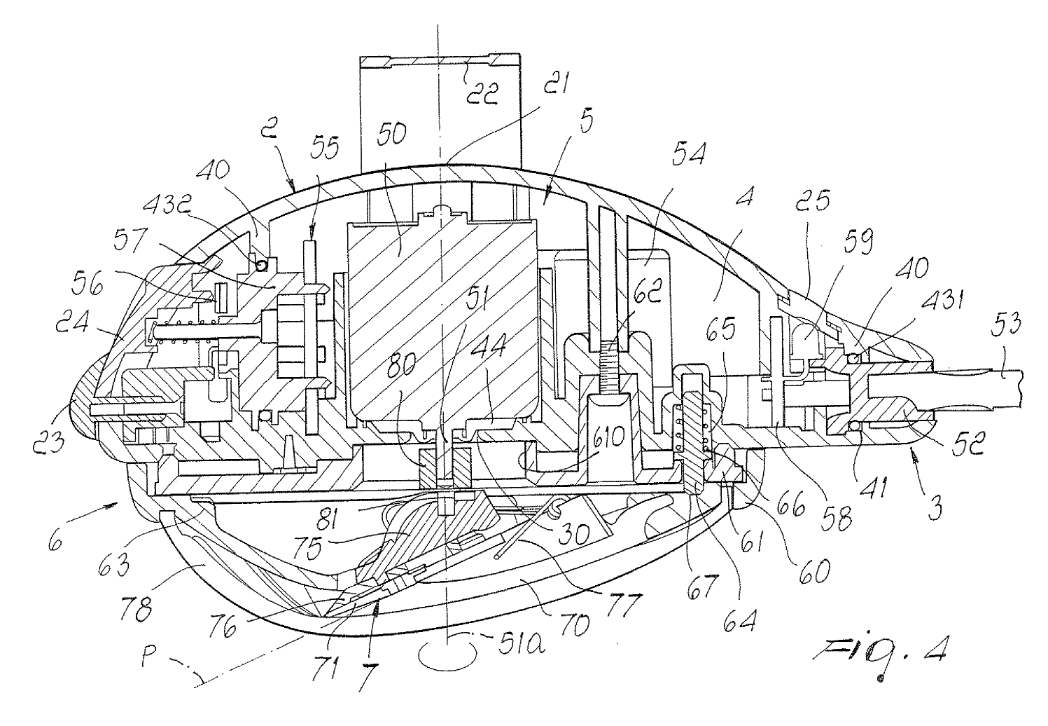

FIGS. 5a-5d are views of four different possible angular positions of the working head of the hair trimmer according to the invention.

### WAYS OF CARRYING OUT THE INVENTION

With reference to the figures, the reference numeral 1 generally designates a manual hair trimmer.

The trimmer 1 comprises an upper shell 2 and a lower shell 3, which are mutually coupled by interlocking and so as to form a seal against external infiltrations, so as to constitute a containment body which is closed and internally hollow.

A chamber 4 is defined inside said containment body and is sealed, i.e., hermetic against infiltrations from the outside environment, and accommodates a motor drive 5.

It is noted that in the present description, the adjectives “upper” and “lower” refer to the active configuration of the trimmer 1; in particular, the two shells are termed “upper” and “lower” with respect to each other in the configuration in which a user grips the trimmer 1 with the palm of the hand directed toward the head of the person whose hair is being trimmed.

A working head 6 provided with a set of hair trimming blades 7 is associated with the lower shell 3 on the opposite side with respect to the upper shell 2, and means 8 for transmitting motion from the motor drive 5 to the set of blades 7 that protrude downwardly from the lower shell 3 are provided.

The upper shell 2 is shaped like a spherical, ovoid, oval dome or the like, and in any case is provided with a convex surface which is directed outwardly and constitutes a resting surface 21 for the hand of a user.

The lower shell 3 is substantially flat, i.e., flat within usual tolerances, and closes in a downward region the dome of the upper shell 2.

Means for locking the hand of the user when rested on the resting surface 21 are associated with the upper shell 2 and are constituted by a band 22, which is arranged transversely to the length of the hand so as to wrap around its back.

The band 22 has opposite ends anchored to the upper shell 2 and has an adjustable length; in a preferred embodiment, the band 22 is made of a material such as Velcro™.

First walls 40 protrude from the concave surface of the upper shell 2 and mate by interlocking with second walls 41, which protrude from the face of the lower shell 3 that is directed toward the upper shell 2; the first walls 40 and the second walls 41 delimit laterally the chamber 4.

A groove 42 is formed along the perimetric edge of the second walls 41 and accommodates a sealing ring 43.

The motor drive 5 is accommodated inside the chamber 4 and comprises a motor 50, the driving shaft 51 of which is arranged substantially at right angles, i.e., at right angles within the usual tolerances, with respect to the plane formed by the lower shell 3 and is accommodated so as to pass through a hole 30 formed in the lower shell 3.

A gasket element 44 is interposed between the hole 30 and the driving shaft 51.

The motor 50 is of the electric type and the motor drive S further comprises connecting means constituted by an adapter 52 for a connecting cable 53 from the mains.

The motor drive 5 further comprises a set of rechargeable batteries 54, a board 55 for supporting a printed circuit for controlling and actuating the trimmer 1, and a set of switches which can be operated from the outside and the contacts 56 of which are supported by a supporting plate 57, which is anchored to the board 55.

For the actuation of the switches, buttons 23 and 24 are provided, which are locked between the upper shell 2 and the lower shell 3 and are arranged proximate to the area of the resting surface 21 where the fingers are meant to rest.

The button 23 acts on an ON/OFF contact and the button 24 acts on a contact for the actuation of the trimmer 1 at a higher operating speed.

There is also a second printed circuit 58 for indication, which is associated with a luminous indicator 59, such as a LED covered by a cap 25 which is anchored to the upper shell 2.

The batteries 54, the board 55, the printed circuit 58 and the indicator 59 are accommodated inside the chamber 4 in addition to the motor 50.

The adapter 52 and the plate 57, which supports the contacts 56, must be accessible both from the inside and from the outside of the chamber 4; for this purpose, between the first walls 40 and the second walls 41 there are first and second openings 45 and 46, respectively for the passage of the adapter 52 and for the containment of the plate 57.

In order to ensure the hermetic closure of the chamber 4, a first frame 431 and a second frame 432, respectively acting as a gasket for the first opening 45 and for the second opening 46, are formed along the sealing ring 43.

The chamber 4 is therefore sealed by the sealing ring 43 and by the gasket element 44, which ensure tightness against any infiltration from the outside environment.

The working head 6 and the motor drive 5 are therefore accommodated in separate locations.

The working head 6 is associated with the lower shell 3 so that it can rotate about a rotation axis which is perpendicular to the plane formed by said lower shell 3 and coincides with the axis 51a of the driving shaft 51.

As indicated by the arrows F, the working head 6 can rotate through a full circle in both directions of rotation, and means for stopping the working head 6 in preset angular positions, described in greater detail hereinafter, are provided.

The rotation of the working head 6 allows to orient the set of blades 7 depending on the area of the head where hair is to be trimmed.

The working head 6 comprises an annular body 60, which is coupled so that it can rotate about the rotation axis 51a to an annular base 61, which is anchored, by means of screws 62, to the face of the lower shell 3 that lies opposite the upper shell 2.

A cam-and-follower mechanism is formed between the annular body 60 and the annular base 61 for guiding and stopping the rotation of the annular body 60.

Said cam-and-follower mechanism comprises a cylindrical cam 63, which is formed on the face of the annular body 60 that is directed toward the annular base 61 and is concentric, within tolerances, with respect to the rotation axis 51a.

The lower end of a follower 64 slides along the cam 63 and is associated with the annular base 61 so that it can slide with a reciprocating rectilinear motion along a direction which is parallel to the rotation axis 51a. The opposite end of the follower 64 is accommodated in a sliding guide 65, which is formed between the lower face of the lower shell 3 and the upper face of the annular base 61.

Elastic pusher means are accommodated within the guide 65 and are constituted by a spring 66, which keeps the lower end of the follower 64 in contact with the cylindrical cam 63.

The cylindrical cam 63 defines a path for the sliding of the lower end of the follower 64, and along said cam there are one or more recesses 67 for stopping the follower 64 and therefore for stopping the rotation of the annular body 60.

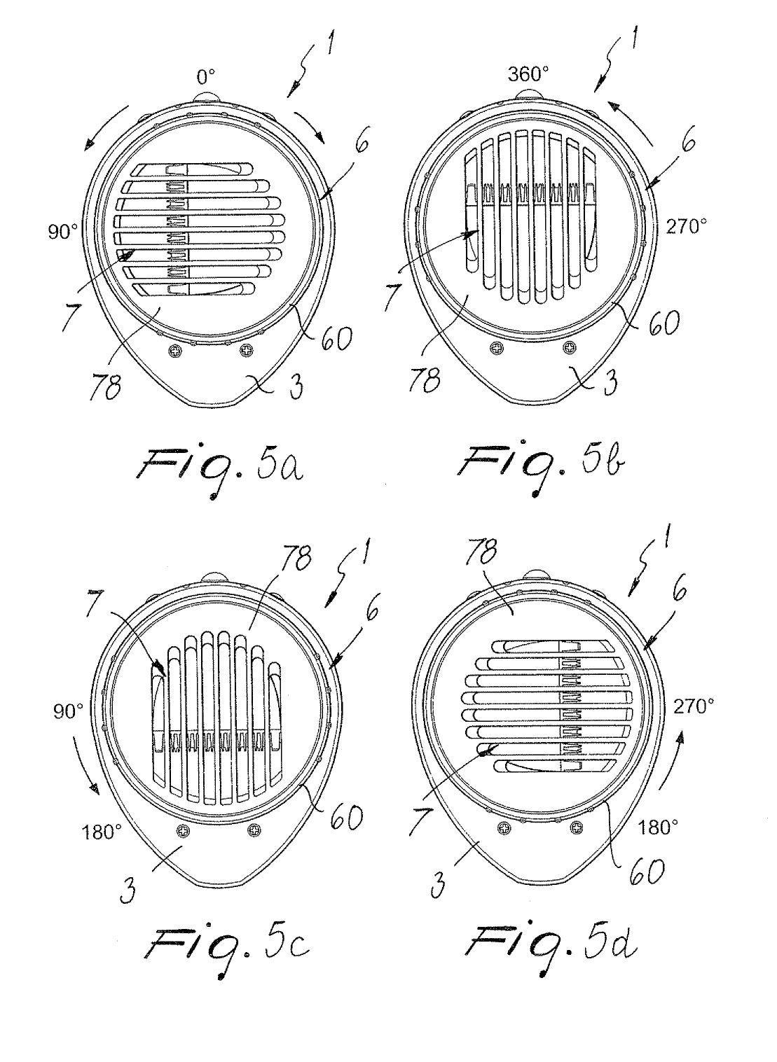

The recesses 67 therefore constitute the means for stopping the rotation of the working head 6 in certain angular positions; in a preferred embodiment, the recesses 67 are hemispherical, are four in number, and are arranged at π/2 rad with respect to each other, the working head 6 assuming therefore four corresponding angular positions (FIGS. 5a-5d).

However, it is also possible to have a smaller or greater number of recesses 67 distributed with a different spacing.

The set of blades 7 rotates rigidly with the annular body 60.

The set of blades 7 comprises a fixed support 70, which is accommodated in a corresponding seat 601 formed in the annular body 60 and on which a fixed blade 71 is mounted.

The fixed support 70 is locked by brackets 72, in which one end is fixed, by means of screws 73, to the annular body 60 and the opposite ends are provided with a lip, which engages by snap action corresponding retention teeth 74, which protrude from the fixed support 70.

A movable support 75 is guided with a reciprocating rectilinear motion along a cutting direction indicated by the arrow T on the fixed support 70.

A cutting blade 76 is anchored to the movable support 75.

The cutting blade 76 is kept pressed against the fixed blade 71 by presser means, which are constituted by a spring 77, in which one end 77a is anchored to the fixed support 70 and the opposite end 77b is anchored in holes formed in the movable support 75.

The fixed blade 71 and the cutting blade 76 that is superimposed thereon and parallel thereto are parallel to a plane P, which is inclined with respect to the plane formed by the lower shell 3 with the respective cutting profiles directed outwardly, i.e., downwardly.

The cutting profiles of the two blades are covered by a comb element 78, which is anchored detachably to the annular body 60; the comb element 78 therefore rotates together with the annular body 60.

Conveniently, there are several comb elements 78 of the interchangeable type for trimming hair to different lengths and grades.

The movable support 75 that supports the cutting blade 76 is associated with the transmission means 8.

The transmission means 8 comprise a wheel 80, which is keyed on the end of the driving shaft 51 that protrudes from the lower shell 3 and is provided with at least one eccentric pivot 81, which engages a slot 79 formed in the movable support 75 substantially at right angles to the cutting direction T.

The wheel 80 is accommodated in a cavity 610 formed in the annular base 61.

Operation of the invention is as follows.

The user rests the palm of the hand on the resting surface 21 and adjusts the band 22 on its back, so as to firmly fasten the trimmer 1 to the hand.

The fingers of the hand thus locked have access to the buttons 23 and 24, by acting on which the trimmer 1 is operated at different operating speeds.

The driving shaft 51 turns and entrains rotationally the wheel 80.

The rotary motion of the wheel 80 is converted into a reciprocating rectilinear motion of the cutting blade 76 along the cutting direction T by virtue of the combination of the guiding of the motion of the eccentric pivot 81 along the slot 79 and the guiding of the motion of the movable support 75 parallel to the cutting direction T.

The cutting blade 76 thus cuts the hair collected by the comb element 78.

If one wishes to change the orientation of the set of blades 7 so as to facilitate hair trimming in a certain region of the head or along a certain direction, it is sufficient to apply to the annular body 60 a pressure in contrast with the action of the spring 66 and simultaneously a twisting action in one of the two directions of rotation.

In this manner, the follower 64 retracts and exits from the recess 67 in which it was temporarily locked; during the rotation of the annular body 60, the lower end of the follower 64 slides along a portion of the path formed by the cylindrical cam 63 until it reaches the next recess 67, inside which it stops, locking the annular body 60, and therefore the set of blades 7 rigidly rotationally coupled thereto, in a different angular position.

The trimmer 1 can be powered by the batteries 54 or directly by the mains.

In practice it has been found that the described invention achieves the proposed aim and objects.

The trimmer according to the invention in fact can be used easily by the individual user without the intervention of other people.

The shape of the trimmer according to the invention makes it particularly easy to grip and handle on the part of the user, who can thus trim his own hair.

In particular, attention is called to the convenience and stability of the grip of the trimmer according to invention offered by the dome-shaped configuration of the upper shell, which defines an ergonomic resting surface for the palm of the hand, and by the presence of the adjustable locking band.

Moreover, attention is called to the position of the actuation buttons, which particularly facilitates operation of the trimmer, and to the arrangement of the set of blades below and obliquely with respect to the body of the trimmer according to the invention.

By way of the rotation in one or both directions and by up to a full circle of the working head of the trimmer according to the invention, it is further possible to vary the orientation of the set of blades depending on the area where hair is to be trimmed.

In the trimmer according to the invention, the motor drive is completely isolated and sealed with respect to the outside environment with perfect tightness against any infiltration and therefore it can be used safely even in humid environments or under the shower.

The invention thus conceived is susceptible of numerous modifications and variations, all of which are within the scope of the appended claims.

All the details may further be replaced with other technically equivalent ones.

In practice, the materials used, as well as the shapes and dimensions, may be any according to requirements without thereby abandoning the scope of the protection of the appended claims.

disclosures in Italian Patent Application no. MI2006A001015, from which this application claims priority, are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1-18. (canceled)

19. A manual hair trimmer, comprising a dome-shaped upper shell and a substantially flat lower shell coupled hermetically to said upper shell, said dome being convex toward the outside so as to define a resting surface for a hand of a user.

20. The trimmer according to claim 19, wherein a sealed chamber for accommodating a motor drive is formed between said mutually coupled upper and lower shells, a working head being provided which has a set of hair trimming blades and is associated with said lower shell on the opposite side with respect to said upper shell, means being further provided for transmitting motion from said motor drive to said set of blades, which protrude from said lower shell.

21. The trimmer according to claim 19, further comprising means for locking the hand of a user to said resting surface, said means being associated with said upper shell.

22. The trimmer according to claim 21, wherein said locking means comprise a band whose length can be adjusted and whose opposite ends are fixed to said upper shell.

23. The trimmer according to claim 19, wherein said dome is substantially spherical or ovoid.

24. The trimmer according to claim 20, further comprising first walls, which protrude from a concave surface of said upper shell and mate with corresponding second walls, which protrude from a face of said lower shell that is directed toward said upper shell, and a gasket ring which is interposed between said first and second walls, said first and second walls delimiting said chamber laterally.

25. The trimmer according to claim 20, wherein said motor drive comprises a motor provided with a driving shaft which is arranged substantially at right angles to a plane defined by said lower shell and is accommodated so as to pass through a hole provided in said lower shell, a gasket element being interposed between said driving shaft and said hole.

26. The trimmer according to claim 25, wherein said motor is of the electric type and is associated with means for connection to the mains, a first opening for the passage of said connecting means being formed between said first and second walls, said gasket ring being provided with a first gasket frame for said first opening.

27. The trimmer according to claim 26, wherein said motor is of the electric type and said motor drive comprises a printed circuit associated with at least one switch which can be operated from the outside the contacts of said switch being supported by a plate accommodated in a second opening formed in said first and second walls, said gasket ring being provided with a second frame acting as a gasket for said second opening.

28. The trimmer according to claim 20, wherein said working head is associated with said lower shell so that it can rotate about a rotation axis which is substantially perpendicular to a plane formed by said lower shell, means for stopping said working head in preset angular positions being provided.

29. The trimmer according to claim 28, wherein said rotation axis coincides with the axis of said driving shaft.

30. The trimmer according to claim 20, wherein said set of blades comprises at least one fixed blade and at least one cutting blade, which can move with respect to said fixed blade with a reciprocating rectilinear motion along a cutting direction and is associated with said motion transmission means, said blades being arranged parallel to a plane which is inclined with respect to a plane formed by said lower shell with the respective cutting profiles directed toward the outside of said working head.

31. The trimmer according to claim 20, wherein said working head comprises an annular body, which is coupled so that it can rotate about said rotation axis to an annular base, which is anchored to a face of said lower shell that lies opposite said upper shell, and a cam-and-follower mechanism provided between said annular body and said annular base, said set of blades being rigidly rotationally associated with said annular body.

32. The trimmer according to claim 31, wherein said cam-and-follower mechanism comprises a cylindrical cam, which is formed on the face of said annular body that is directed toward said annular base and is substantially concentric with respect to said rotation axis, and a follower, which is associated with said base so that it can move with a reciprocating rectilinear motion along a direction which is substantially parallel to said rotation axis and in contrast with elastic pusher means, said stop means comprising at least one recess for stopping said follower which is formed along said cam.

33. The trimmer according to claim 32, wherein said stop means comprise four of said recesses arranged substantially at π/2 rad with respect to each other.

34. The trimmer according to claim 31, wherein said set of blades comprises a fixed support, which is accommodated in a corresponding seat provided in said annular body and on which said fixed blade is fitted, a movable support which is guided with a reciprocating rectilinear motion along said cutting direction on said fixed support, and on which said cutting blade is mounted, and presser means, which are adapted to press said fixed blade and said cutting blade against each other.

35. The trimmer according to claim 34, wherein said transmission means comprise a wheel, which is keyed to said driving shaft and is provided with an eccentric pivot, which engages a slot provided in said movable support substantially at right angles to said cutting direction.

36. The trimmer according to claim 31, wherein said working head comprises a comb element for covering said set of blades which is detachably associated to said annular body and is rigidly and rotationally coupled thereto.
